(19) United States
(12) Patent Application Publication
(10) Pub. No.: US 2007/0043562 A1
(43) Pub. Date: Feb. 22, 2007

(54) Email capture system for a voice recognition speech application

(76) Inventors: David Holsinger, Pescadero, CA (US); Margaret Boothroyd, San Francisco, CA (US)

Correspondence Address: CENTRAL COAST PATENT AGENCY, INC, 3 HANGAR WAY SUITE D, WATSONVILLE, CA, 95076, US

(21) Appl. No.: 11/431,492

(22) Filed: May 9, 2006

Related U.S. Application Data
(60) Provisional application No. 60/703,780, filed on Jul. 29, 2005.

(51) Int. Cl. G10L 15/00

(52) U.S. Cl. 704/231; 379/88.14

(57) ABSTRACT

A system is provided for segmenting a character sting into useable parts and for deriving statistically relevant and searchable patterns from those separate parts. The system includes a corpus containing an initial set of character strings for processing, a corpus processor for identifying and segmenting each of the character strings, a segmentation rule available to the processor, and a pattern generator for generating the patterns.

### CROSS-REFERENCE TO RELATED APPLICATIONS

The present invention claims priority to a U.S. provisional patent application Ser. No. 60/703,780, filed on Jul. 29, 2005.

### BACKGROUND OF THE INVENTION

1. Field of the Invention

The present invention is in the field of voice-enabled speech recognition applications and functions pertaining particularly to methods and apparatus for building a pattern index for recognizing voice commands through a speech application related to specific email parameters and email tasks for the purpose of performing those related tasks through a speech application.

2. Discussion of the State of the Art

In the field of computer aided voice recognition, speech applications are known in the art and are available on computerized systems supporting voice recognition technology (VRT). Speech applications are applications adapted to perform computer or network related tasks based on recognition of certain spoken commands input into the system. Some of these applications are unidirectional meaning that they perform tasks based on voice input but are not adapted for voice response to the user, while others are fully capable of bi-directional voice interaction and task performance.

Generally speaking, a speech application leverages some form of grammar base of known grammar sets in order to be able to associate a spoken word or phrase to the digital equivalent or pattern stored in a pattern index.

One area that remains a challenge for voice recognition systems or applications is the ability to recognize email addresses. A common method for recognizing spoken content is use of a pattern index leveraging conditional probability, for example predicting the rest of the data after the first portion is spoken. A major obstacle for email is that email has no specific or standard format or particular syntax to follow. In particularly, the alphabet and numerical characters often associated with email has low speech recognition accuracy characteristics. For example one address may be abc1234@hotmail.com while a different address may be james robert1999@blazz.tv rendering recognition and identification of both addresses a technical challenge. Recognition challenges may arise with such characters as “c” and “z”, “m” and “n”, and so on. The ability to capture the full string of characters in order to restructure the original email with high recognition accuracy and efficiency is a technical challenge.

Because of the non-standard formatting described above, voice applications using speech recognition may be required to recognize one character at a time in an email string, for example. This can be frustrating and time consuming for a user and the application may not perform reliably. The net result would be that every single character of the string would have to be spoken. Even in this case, many speech recognition engines have some trouble differentiating between certain characters.

Some vendors offer professional service engagements adapted to mitigate the problems defined above. The result is an increased total cost of ownership (TCO) for the system. Therefore, what is clearly needed are methods and apparatus, including framework, for facilitating more reliable voice recognition of email having poor syntax or format uniformities. Such a system could be provided in a robust, user friendly, scalable, and cost-efficient manner.

### SUMMARY OF THE INVENTION

A system is provided for segmenting a character sting into useable parts and for deriving statistically relevant and searchable patterns from those separate parts. The system includes a corpus containing an initial set of character strings for processing, a corpus processor for identifying and segmenting each of the character strings, a segmentation rule available to the processor, and a pattern generator for generating the patterns.

In a preferred embodiment, the character strings are email addresses and the segmentation rule results in segmentation of those strings into three logical parts. In this embodiment, specific characters of the character string are common to all of the strings in the corpus and are not included in any of the three segments of any string. In this embodiment, those characters common to all of the strings in the corpus are the @ character and the dot character immediately before the domain indication of the string. In one embodiment, the system includes a grammar rule generator for deriving all possible complete character strings from the patterns generated from the segments of corpus email strings.

According to another aspect of the invention, an email capture interface is provided that may be integrated into a speech application. The email capture interface includes a first voice prompt for soliciting a first voice response of a first email address segment, a second voice prompt for soliciting a second voice response of a second email address segment, and a third voice prompt for soliciting a third voice response of a third email address segment. In a preferred embodiment, pattern conversions and pattern searches against a pattern index occur separately for each voice response whereupon after the first response an attempt to predict the rest of the email address through statistical pattern relevancy is made, the attempt repeated again after the second response in the event of failure after the first attempt.

In a preferred embodiment, the first voice response is account name, the second voice response is the company name, and the third voice response is the domain name. In one embodiment, the email capture interface further includes a voice prompt soliciting confirmation after receiving and ambiguously recognizing any of the three voice responses.

According to another aspect of the present invention, a method for building a pattern index from a corpus of email addresses is provided. The method includes acts for (a) sorting and parsing the email strings in the corpus to isolate common segments of those strings, (b) deriving patterns for the isolated segments, (c) indexing those patterns for data searching according to statistical relevancy, (d) deriving all of the possible complete patterns representing possible complete emails from the segment patterns derived; and (e) indexing the complete email patterns according to statistical relevancy.

In a preferred aspect, in act (a), the common segments are separated by the character @ and a dot character occurring immediately before the domain designation of the email address.

In yet another aspect of the invention, a method for fine tuning a grammar base used with a running speech application adapted, at least in part, for recognizing spoken email address segments is provided. The method includes acts for (a) failing to recognize a spoken email address, or address segment beyond a preset threshold of ambiguity, (b) prompting a caller for confirmation of yes or no of the ambiguous email address or address segment, (c) receiving confirmation of the ambiguous email address or address segment, and (d) updating the logic used to maintain the grammar baser with the confirmed parameter.

In a preferred aspect, in act (a), the threshold value defines a boundary between full recognition and ambiguous recognition. In one aspect, in act (b), the system prompt voices the most statistically relevant pattern found first. In this aspect, in act (d), the confirmed pattern is that of an email address segment.

According to one aspect of the method, in act (b), the response to the prompt is no and the act is repeated a preset number of times until the confirmation response is yes, or the process ends without recognition. Also in one aspect, in act (c), the ambiguity was not resolved, and an additional act is dynamically provided to access a customer resource management (CRM) database to attempt to retrieve the correct parameter. According to variation of that aspect an additional act is added to prompt for confirmation of the parameter retrieved from the CRM database.

### BRIEF DESCRIPTION OF THE DRAWING FIGURES

FIG. 1 is a block diagram of email pattern index builder application according to an embodiment of the present invention.

FIG. 2 is a block diagram illustrating grammar segmentation used to build a pattern recognition database according to an embodiment of the present invention.

FIG. 3 is a process flow chart illustrating acts for forming a pattern index useable by a speech application to recognize voice patterns related to email addresses according to an embodiment of the present invention.

FIG. 4 is a process flow chart illustrating acts capturing an email address spoken through an email capture interface integrated with a speech application.

### DETAILED DESCRIPTION

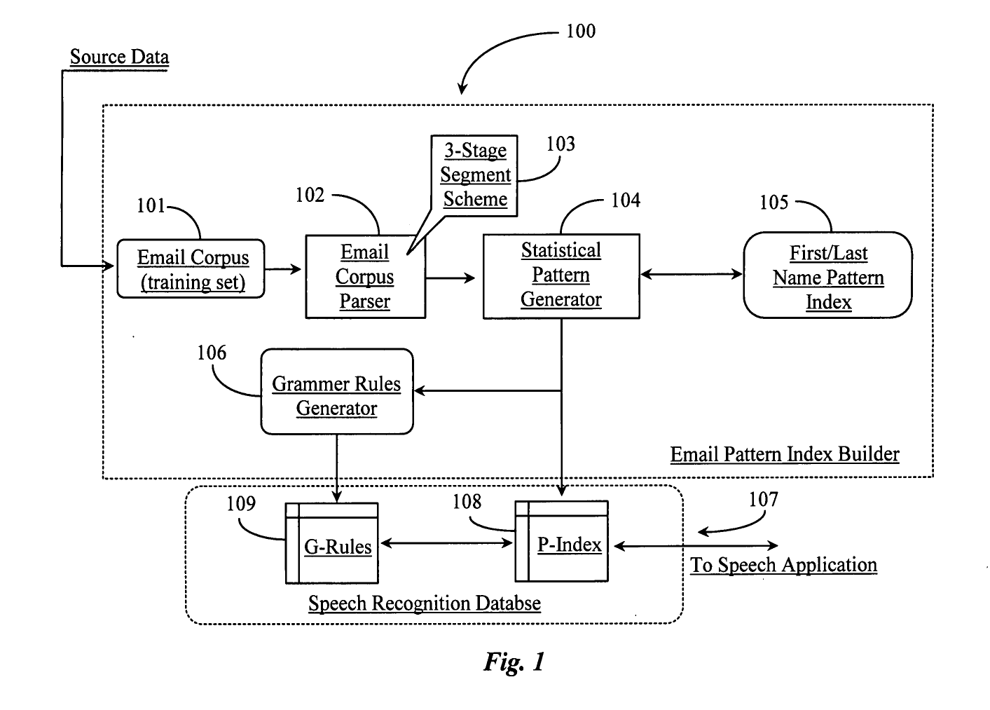

FIG. 1 is a block diagram of email pattern index builder application 100 according to an embodiment of the present invention. Pattern index builder 100 is, in a preferred embodiment, a software application that enables a user to build a reliable voice recognition pattern index from a training set of parameters or grammar. As described further above with reference to the background section, known words and phrases have predictable syntax and formats while email addresses typically do not. Therefore, a method is needed to build an index that can be used efficiently and reliably.

Application 100 takes source data as input for building a pattern index. In this example, the source data input into the application is an existing email corpus or training set 101. This email corpus would be a listing of many thousands or even millions of existing email addresses, perhaps known to an enterprise that will eventually use the voice recognition capabilities of the system of the invention to capture email. One example of an email corpus on a grand scale would be all of the addresses registered with AOL. Another on a smaller scale might be all of the email addresses of customers of a local enterprise selling computer systems. The actual training set might depend on what enterprise will use the system and, to some extent, how the system will be configured.

One reliable structure that may be associated with a typical email address is that there is an @ sign and at least one dot. Invariably, there is some user identification data or account identification data before the @ sign. Also there is some company or organization identification data immediately after the @ sign and before the dot. Likewise, there is some domain data immediately after the dot. Some email addresses, such as some government addresses have an additional dot in the string to identify a state university or institution for example, xxx@ca.univ.edu. Still, the last characters after the last dot are considered the domain.

Corpus 101 is sorted and parsed by an input or corpus processor 102. Processor 102 will separate like segments into classes using a segmentation scheme identified herein as a 3-stage segment scheme 103. In a preferred embodiment, scheme 103 is a template used with one or more rules that direct the corpus processor 102 to break down each email address from corpus 101 into separable grammar segments. These segments, in a preferred embodiment, are (1) everything before the @ sign as a first segment; (2) everything after the @ sign but before the last dot as a second segment; and, (3) everything after the last dot as a third and final segment for consideration. Therefore, user ID, which may be most often considered the account ID, company or organization ID, and domain indication characterize the three segments in order.

In a preferred embodiment, the segment scheme 103 is used to build a more structured and reliable pattern index and also used as a segmented email capture interface for voice recognition as will be described later in this specification. Application 100 has a statistical pattern generator 104 provided thereto and adapted to derive statistically relevant patterns from each of the segments of the emails. Generator 104 is, in a preferred embodiment, integrated with a state-of-art first/last name pattern index 105 to further aid in building a reliable pattern index for email capture.

A grammar rules generator 106 is provided to application 100 and adapted to generate all of the possible emails that may be derivable through the pattern index created by generator 104. The result is a complete speech recognition database 107 including an up-to-date pattern index 108 and grammar rules base 109. Speech recognition database is accessible to a speech application running an email capture interface that interacts with a caller to deduce one or more email parameters uttered by the caller. In other words, instead of asking a caller to spell out a full email address, the capture interface prompts for the address based on the individual segments used to generate the pattern index. More detail about this feature of the present invention will be provided later in this specification.

One with skill in the art of statistical pattern recognition will appreciate that there are many known ways of building and organizing a pattern database and also many known ways for enabling real-time recognition of input speech using a pattern recognition database. Template based methods statistical language modeling, the use of Markov modeling, and the like represent some basic modalities. In a preferred embodiment, the pattern index is created using statistical language modeling according to the segmenting scheme mentioned. The goal of the present invention is to break up both the pattern building and actual voice capture interface into the structural segments mentioned above when it comes to email addresses. In this way, capturing email addresses at a voice interface is much more reliable. Theoretically speaking, the methods of the present invention may reliably capture 80% of any emails the system is expected to capture based on speech application input voice recognition. The remaining 20% may be learned through prompting and conformation procedures performed at the capture interface.

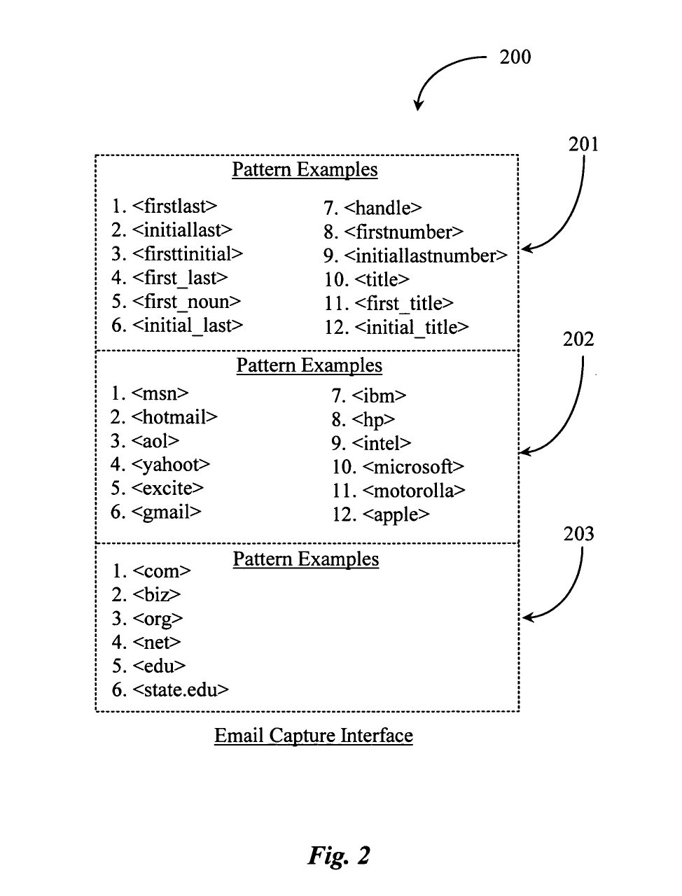

FIG. 2 is a block diagram 200 illustrating grammar segmentation used to build a pattern recognition database according to an embodiment of the present invention. As described further above, email address data is, in a preferred embodiment, segmented into three useable pattern classes. In this example, these pattern classes are lists of pattern examples labeled herein as pattern examples or class 201, pattern examples or class 202, and pattern examples or class 203. In this example, we will refer to each list as a class.

The first class 201 represents all of the data that may proceed the @ sign in an email address. Thus, many known patterns of this class may be derived. In this exemplary list there are 12 relatively common patterns listed but it will be apparent to one with skill in the art that there may be many more derived patterns than those listed in this example. Name based patterns, defined as a pattern including at least some component of the users name, can include many different patterns. A very simple pattern like <firstlast>, or first lame immediately followed by last name, is listed number 1 in class 201. Symbols like an underscore are common separators of names and initials in email account strings. Such examples are listed as patterns 4, 5, and 6.

In some cases, no name data is included in the account identification of an email address. Such examples are listed as number 7 and 10 where a created handle or a title of the user takes the place of a user name. Likewise, there are often number strings associated with name data do differentiate account holders of the same name from each other, patterns 8 and 9 show number insertion after name data. As previously described, there are many possibilities and the inventor deems the 12 pattern examples types listed sufficient for illustrative purpose.

Class 202 contains pattern examples of what might be after the @ sign but before the dot in an email address. Typically this portion of an email address identifies the provider of the email service the user has subscribed to. In this example, there are 12 listed pattern examples for this segment of the email address. Known email providers like MSN, AOL, and Yahoo make the list, as well as companies like IBM, HP, Intel and the like. It is clear that there may be many more examples listed than the 12 shown here in class 202.

Class 203 includes all relevant domain patterns or everything after the dot or the domain of the email address. Of these examples, the most common 6 are listed herein as com, biz, org, net, edu, and state.edu. The purpose again of this segmentation scheme is to generate grammar that is more likely to be matched through the voice interface without requiring the caller to spell out every single character. In this way many new voice services may be implemented that might enable enterprises, for example, to register new users for email without requiring a type interface. Likewise many email management voice interfaces may be envisioned for enterprises whose workers share an email router or server.

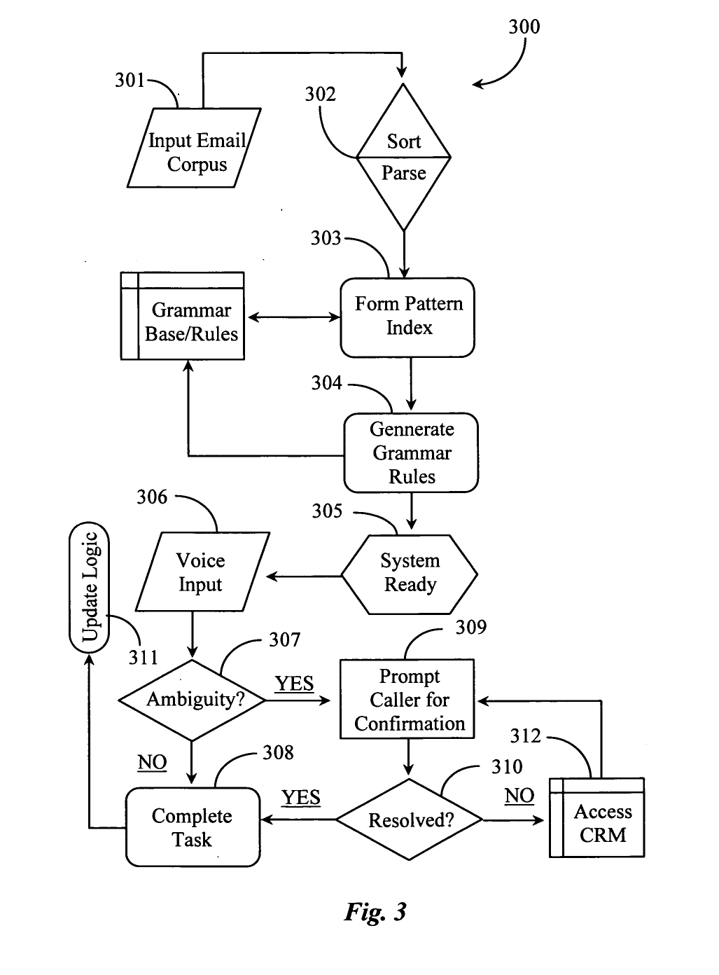

FIG. 3 is a process flow chart 300 illustrating acts for forming a pattern index useable by a speech application to recognize voice patterns related to email addresses according to an embodiment of the present invention. At act 301, an email corpus is input into the pattern index builder application. The email corpus may be any conceivable list of email addresses. At act 302, the email corpus is sorted and parsed to break down the email strings into their appropriate structural segments discussed further above. In this act, other optimizations may be used such as consulting other pattern indexes, for example, a first name-last name index. The optimization may include use of multiple phonemes; multi-slot variations and other optimization techniques such as are known to the inventor and available for leverage to facilitate natural language recognition.

At act 302, the emails are sorted and parsed in a corpus processor according to a segmenting scheme that breaks down each email address into its separable structural parts or account name, account host and domain name. In addition to any other optimizations, a pattern index is formed in act 303. This act derives statistically relevant patterns and relationships among and between the separable segments.

At act 304, a rules generator generates the grammar rules that govern restructuring of the emails from their parts. In this act all of the possible derivations of emails that may be constructed from the segments are considered. At act 305 after a pattern index is formed and tested sufficiently, the system is ready to be used by callers.

At act 306, the speech application is executed and accepts voice input from callers during the normal course of the application and according to its design. The speech application may have many parts in addition to the part enabling reliable recognition of an email address. With respect to the portion that recognizes email or email capture module, at act 307 the system decides whether there is any ambiguity in the recognition of a spoken email address. If not then at act 308, the system completes whatever task intended in relation to the spoken address. In this case, the system has performed as desired, in other words, the command was recognized fully.

In a preferred embodiment, the email capture interface of the speech application also breaks down the email prompt into the three segments already mentioned comprising 3 recognition states for that email address as opposed to prompting the caller to spell out the entire email address enunciating every word and character. For example, the system first prompts the caller for the first segment or the data before the @ sign. Then the system prompts for the second segment and so on until the email address is recognized or, in some cases, learned. In the latter case, the service may include registration of a new user wherein the caller creates an email address that cannot be derived from the pattern index.

At act 307, if there is ambiguity regarding a recognition task, then at act 309 the caller may be prompted for confirmation or clarification of what was said. It is important to note herein that act 307 may be performed for each recognition state, for example, for all 3 email segments. In a case where the target email is one of the emails derivable from the pattern index, he or she may not be required to speak each of the segments for 100% recognition.

At act 310 the system decides if it has resolved, at act 309, the ambiguity resulting from an affirmative decision at act 307. If so, the process moves again to act 308 wherein the intended task is completed by the system. In this case, any new variant or existing information learned by the system, or any new input can be used to update the recognition logic at act 311 to fine-tune the system for more accuracy.

If at act 310, an issue cannot be resolved using voice interaction between the caller and the application, at act 312, the system (speech application) may initiate access of a customer resource management (CRM) database that might contain the caller's information including the ambiguous email parameters. The system then can generate a new confirmation voice prompt to the caller (act 309 repeated) wherein the data accessed from the CRM database may be spoken to the caller to see if that is what the caller was trying to say. Again at act 310, if the system has finally resolved the ambiguity then acts 308 and 311 may be completed.

To illustrate one simple voice interaction example covering acts 306 through 311, assume that a speech application is registering a new user to a portal shared by several existing companies. Assume that each registrant may create an email account for use with the portal. Also assume that the user is accessing the speech application by telephone.

System: Would you like to create an account? Caller: Yes. System: State your desired email account name. Caller: johnbasil. System: johnbasil is taken but johnb is not taken. Would you accept johnb? Caller: yes. System: please state your company name. Caller: International Business Systems. System: Thank you for creating an account with us! Your email address for this account is johnb@ibm.com. You may now send and receive email using this account.

In a preferred embodiment of the present invention, a speech application may be enhanced with an email capture interface that provides the basis for the system to quickly and reliably recognize spoken email addresses.

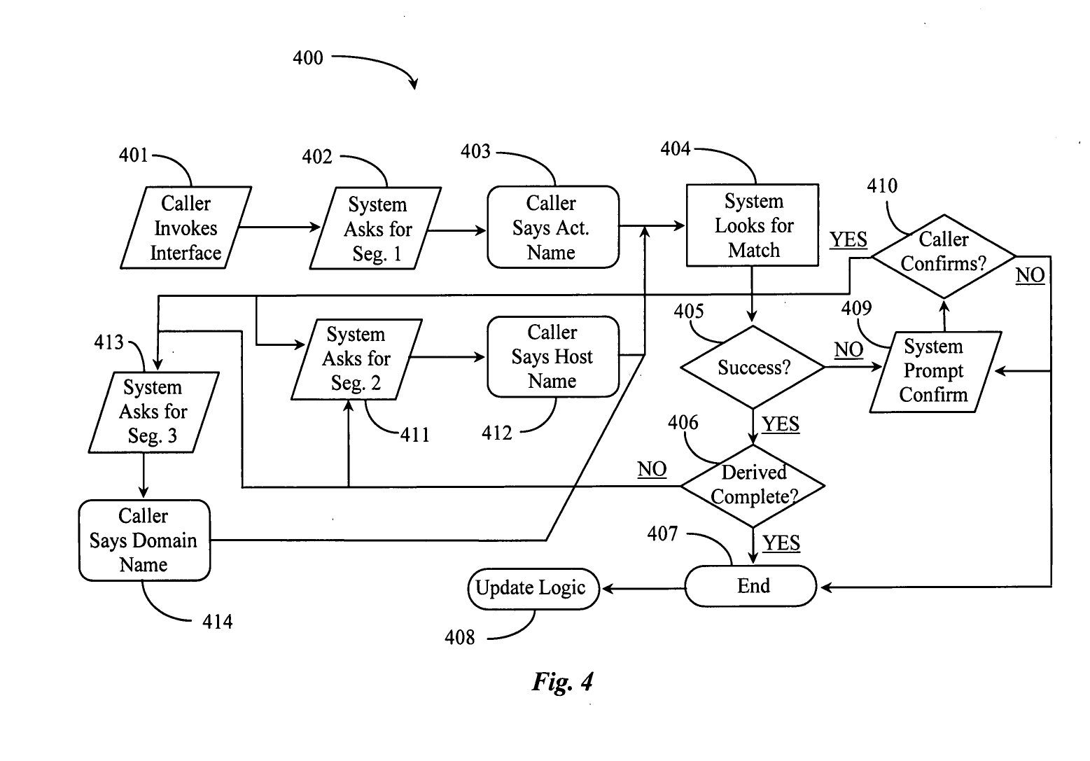

FIG. 4 is a process flow chart 400 illustrating acts capturing an email address spoken through an email capture interface integrated with a speech application. At act 401, a caller invokes the email capture interface. This act may occur anywhere in a speech application that requires an email parameter. At act 402, the system asks the caller for the first email segment. This will include anything before the @ sign of the email address string. At act 403, the caller responds by saying the account name, for example, johnb.

At act 404, the system looks for a match to an existing pattern in the pattern index. At act 405, the system decides if the lookup was a success. If the answer is yes at act 405, then at act 406, the system decides if the rest of the string can be predicted completely. The system may do this during the original lookup or by a second access to determine if the first pattern points to only one possible subsequent pattern string, thus completing the email reconstruction. Although this may not be likely in a robust system, it is possible. If the answer is yes at step 406, then the process may end at step 407, the entire email string recognized by the first segment.

If the answer is no at act 405, then at act 409, the system may prompt the caller for confirmation. In this act, the system may have several possibilities to say to the caller for a yes or no confirmation on each of those. At act 410, the caller confirms or does not confirm. If at act 410 the caller does not confirm (NO) then the process may loop back to act 409. After a threshold number of these attempts, if the caller still does not confirm then the process may resolve to end at act 407.

If the caller does confirm one of the prompted results at act 410, then at act 411, the system asks for segment 2. Also, if the answer was yes at act 405, but no at act 406, then the process logically moves to act 411. In either case, after act 411, the caller says the host or company name at act 412. The process again moves to act 404 wherein the system looks for a matching pattern. The system has remembered the first pattern so if at act 405 the match is a success (YES), then at act 406 the system again decides whether the rest of the string may now be predicted accurately. If yes, then at act 407, the process may end.

If at act 405, the system was not successful finding a match for the second email segment spoken in act 412, then the system may prompt the caller for confirmation at act 409 as described above for the first segment. If the caller does not confirm for a threshold number of times, then the process may end at act 407. However, if the caller confirms at act 410, then at act 413, the system asks for the third segment. Likewise, if the system was successful at matching the first two segments, but still could not predict the third segment, then the process moves to act 413. In ether case, at act 414, the caller says the domain. The system attempts to find a match at act 404 and at act 405 the system determines if the match is successful. In this case, if the system finds a match at act 405 then the process is completed at act 407 because the entire email string has been successfully reconstructed for the purposes of the speech application flow. Act 407 would not be necessary.

If at act 405, the answer is no after the first two segments are known, then the system may again prompt the caller for confirmation for the domain of the string. This process may repeat or loop several times until a confirmation is made. It is most likely that if the first 2 segments are known the last segment can be reliably predicted based on statistical pattern relationship between the company name or host and what domain that company or host uses. However, if the company or host is known to use more than one domain, i.e. there is more than one possible pattern then confirmation might ensue. If there is a confirmation act required for the final email segment and the caller confirms, then the process skips to act 407 and ends. It is noted herein that after act 407, regardless of stage, act 408 may be practiced if there is any new information to provide to voice recognition logic.

The method and apparatus of the present invention may be practiced in conjunction with other methods to build pattern recognition databases for voice recognition systems. These may include such known methods known to the inventor such as statistical language modeling, use of Markov model, and use of neural network techniques without departing from the spirit and scope of the present invention. Thus enhanced capabilities for capturing spoken email may be integrated in a speech application that recognizes other language spoken in the process of navigating services that might be offered.

The method of the present invention may be practiced to create large-scale or smaller scale voice recognition databases on site of a user by packaging the capabilities in the form of an exportable tool kit. Likewise, smaller scale voice recognition databases may be distributed with software to small business or private citizens whereupon those users may further tune those databases on site. There are many use case possibilities envisioned as viable services that may benefit from the ability to quickly and reliably recognize voice spoken email strings. Large sales or service organizations may leverage the capabilities of the present invention to obfuscate the requirements of a type interface for entering required email information. Therefore, access to services requiring email confirmation may be, more practically, provided over the phone or other voice channels for example. There are many possibilities.

The spirit and scope of the present invention should be afforded the broadest interpretation under examination. The spirit and scope of the present invention shall be limited only by the claims, which follow.

What is claimed is:

1. A system for segmenting a character sting into useable parts and for deriving statistically relevant and searchable patterns from those separate parts comprising:
a corpus containing an initial set of character strings for processing;
a corpus processor for identifying and segmenting each of the character strings;
a segmentation rule available to the processor; and
a pattern generator for generating the patterns.

2. The system of claim 1, wherein the character strings are email addresses and the segmentation rule results in segmentation of those strings into three logical parts.

3. The system of claim 2, wherein specific characters of the character string are common to all of the strings in the corpus and are not included in any of the three segments of any string.

4. The system of claim 3, wherein those characters common to all of the strings in the corpus are the @ character and the dot character immediately before the domain indication of the string.

5. The system of claim 1, further including a grammar rule generator for deriving all possible complete character strings from the patterns generated from the segments of corpus email strings.

6. An email capture interface integrated into a speech application comprising:
a first voice prompt for soliciting a first voice response of a first email address segment;
a second voice prompt for soliciting a second voice response of a second email address segment;
a third voice prompt for soliciting a third voice response of a third email address segment;
characterized in that pattern conversions and pattern searches against a pattern index occur separately for each voice response whereupon after the first response an attempt to predict the rest of the email address through statistical pattern relevancy is made, the attempt repeated again after the second response in the event of failure after the first attempt.

7. The email capture interface of claim 6, wherein the first voice response is account name, the second voice response is the company name, and the third voice response is the domain name.

8. The email capture interface of claim 6 further including a voice prompt soliciting confirmation after receiving and ambiguously recognizing any of the three voice responses.

9. A method for building a pattern index from a corpus of email addresses including acts for:
(a) sorting and parsing the email strings in the corpus to isolate common segments
of those strings;
(b) deriving patterns for the isolated segments;
(c) indexing those patterns for data searching according to statistical relevancy;
(d) deriving all of the possible complete patterns representing possible complete emails from the segment patterns derived; and
(e) indexing the complete email patterns according to statistical relevancy.

10. The method of claim 9, wherein in step (a), the common segments are separated by the character @ and a dot character occurring immediately before the domain designation of the email address.

11. A method for dynamically fine tuning a grammar base used with a running speech application adapted, at least in part, for recognizing spoken email address segments including acts for:
(a) failing to recognize a spoken email address, or address segment beyond a preset threshold of ambiguity;
(b) prompting a caller for confirmation of yes or no of the ambiguous email address or address segment;
(c) receiving confirmation of the ambiguous email address or address segment; and,
(d) updating the logic used to maintain the grammar baser with the confirmed parameter.

12. The method of claim 11, wherein in act (a), the threshold value defines a boundary between full recognition and ambiguous recognition.

13. The method of claim 11, wherein in act (b), the system prompt voices the most statistically relevant pattern found first.

14. The method of claim 11, wherein in act (d), the confirmed pattern is that of an email address segment.

15. The method of claim 11, wherein in act (b), the response to the prompt is no and the act is repeated a preset number of times until the confirmation response is yes, or the process ends without recognition.

16. The method of claim 11, wherein in act (c), the ambiguity was not resolved and an additional act is dynamically provided to access a customer resource management (CRM) database to attempt to retrieve the correct parameter.

17. The method of claim 16, wherein an additional act is added to prompt for confirmation of the parameter retrieved from the CRM database.
